(19) United States
(12) Patent Application Publication
(10) Pub. No.: US 2015/0334652 A1
(43) Pub. Date: Nov. 19, 2015

(54) SELECTIVELY POWERING INLINE DEVICES OF A NETWORK DEVICE BASED ON CLIENT DEVICE PRESENCE

(71) Applicant: Cisco Technology, Inc., San Jose, CA (US)

(72) Inventors: Saurav Prasad, Dublin, CA (US); Kabiraj Sethi, San Jose, CA (US); Vimarsh Puneet, Milpitas, CA (US)

(21) Appl. No.: 14/571,466

(22) Filed: Dec. 16, 2014

Related U.S. Application Data
(60) Provisional application No. 61/994,210, filed on May 16, 2014.

(51) Int. Cl. H04W 52/02; H04W 8/24

(52) U.S. Cl. CPC H04W 52/0212; H04W 8/24

(57) ABSTRACT

A network device includes ports to communicate with and provide power to devices connected thereto. The network device serves access points (APs) that connect wirelessly to client devices. The network device detects that a client device has wirelessly connected to or disconnected from an AP that is connected to the network device. Responsive to the detecting, the network device accesses predetermined power control information associated with the client device. If the power control information identifies one or more of the multiple ports, the network device selectively provides power to the identified one or more ports when the client device is detected as being connected to the AP and removes power from the identified one or more ports when the client device is detected as not being connected to the AP.

### CROSS REFERENCE TO RELATED APPLICATION

This application claims priority to U.S. Provisional Application No. 61/994,210 filed May 16, 2014, the entirety of which is incorporated herein by reference.

### TECHNICAL FIELD

The present disclosure relates generally to power reduction at a network device.

### BACKGROUND

A network switch may include multiple Power-over-Ethernet (PoE) network ports through which the switch communicates with and provides power to in-line devices (also referred to as “powered devices”) connected to the ports. The network switch may also include numerous status lights mounted to chassis panels of the network device to indicate network port activity and other system status. The in-line devices and status lights draw a substantial amount of power from the network device. Moreover, the in-line devices and status lights spend a large portion of their operational lifetimes powered-on, but not actually needed or used by various client/users or administrators associated with the in-line devices and the status lights. This results in a substantial power waste by and unnecessary power draw from the network device.

### BRIEF DESCRIPTION OF THE DRAWINGS

FIG. 1 is a block diagram of an example network environment in which embodiments presented herein may be implemented, according to an example embodiment.

FIG. 2 is a block diagram of an example network device from FIG. 1, according to an example embodiment.

FIG. 3 is a flowchart of an example method of reducing power consumption at a network device based on power control profiles associated with client devices, according to an example embodiment.

FIG. 4 is an illustration of example network device location information in a power control database accessed by the network device in the method of FIG. 3, according to an example embodiment.

FIG. 5 is an illustration of example access point (AP) connection information that associates network device identifiers with corresponding AP identifiers in the power control database, according to an example embodiment.

FIG. 6 is an illustration of example client device information that associates client device identifiers with other information in the power control database, according to an example embodiment.

FIG. 7 is an example of a user (role) power control profile identified in the client device information of FIG. 6, according to an example embodiment.

FIG. 8 is an example of an administrator (role) power control profile identified in the client device information of FIG. 6, according to an example embodiment.

FIG. 9 is an illustration of dynamic information stored in the power control database, according to an example embodiment.

### DESCRIPTION OF EXAMPLE EMBODIMENTS

### Overview

A network device includes multiple ports to communicate with and selectively provide power to powered devices connected to corresponding ones of the ports. The network device serves access points (APs) that connect wirelessly to client devices. The network device detects that a client device has wirelessly connected to or disconnected from an AP that is connected to the network device. Responsive to the detecting, the network device accesses predetermined power control information associated with the client device. If the power control information identifies one or more of the multiple ports, the network device selectively provides power to the identified one or more ports when the client device is detected as being connected to the AP and removes power from the identified one or more ports when the client device is detected as not being connected to the AP.

### Example Embodiments

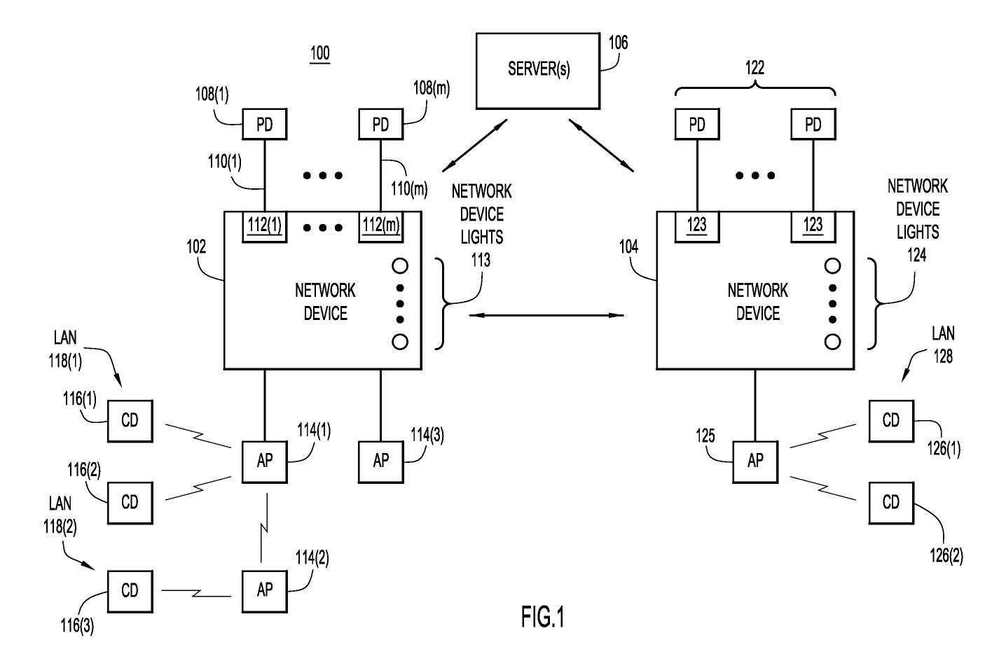

Referring first to FIG. 1, there is shown a block diagram of an example network environment 100 in which embodiments to save or reduce power consumption at a network device may be implemented. Network environment 100 includes multiple network devices 102 and 104, such as network switches, and server(s) 106 to store information that may be used by the network devices. In an embodiment, network devices 102 and 104 are converged wired-wireless network switches. Devices 102-106 may all be co-located at one geographical location or the devices may be located at separate geographical locations. Devices 102-106 communicate with each other over communication networks (not shown in FIG. 1) that include wide area networks (WANs), such as the Internet, and local area networks (LANs). In practice there may be many more network devices and servers than are depicted in FIG. 1.

Network device 102 connects with multiple powered devices (PDs) 108(1)-108(M) through cables 110(1)-110(M) connected between the PDs and network ports 112(1)-112(M) of the network device. PDs 108 are also referred to as in-line devices 108. PDs 108 may include a wide range of devices, such as cameras, smartphones, lights, Internet-of-Things (IOT) devices, and the like. Network device 102 and PDs 108 exchange bi-directional data with each other over cables 110. Additionally, network device 102 acts as a controlled power source to selectively provide power (i.e., voltage and current) to or remove power from various ones of PDs 108 through respective ones of ports 108 to which the PDs are connected. To this end, network device 102 may be a Power-over-Ethernet (PoE) enabled network switch that acts as power source equipment (PSE) to provide PoE power and data to PDs 108 (through the network ports 112) substantially in accordance with the IEEE 802.3 specification/standard.

Network device 102 also includes multiple network device lights 113(1)-113(N), such as light emitting diodes (LEDs), mounted to a chassis of the network device (not shown in FIG. 1) to indicate different network device statuses when the lights are powered. Network device lights 113 include port activity lights 113(1)-113(M) to indicate network port activity, if any, on each of network ports 108(1)-108(M), respectively, and additional system lights 113(M+1)-113(N) to indicate various system conditions of the network device. The lights are typically light emitting diodes (LEDs).

Network device 102 also controls multiple wireless access points (APs) 114(1), 114(2), and 114(3) served by the network device. APs 114 may have wired or wireless connections to the network device, or only indirect logical connections to the network device. For example, AP 114(1) may have a wired connection with network device 102, while AP 114(2) may communicate with the network device through AP 114(1) using wireless backhaul links to AP 114(1). Generally, APs 114 serve wireless client devices (CDs) 116, e.g., wireless mobile devices, that operate on respective LANs 118 associated with the APs. For example, AP 114(1) serves wireless client devices 116(1) and 116(2) on a LAN 118(1) associated with that AP. Similarly, AP 114(2) serves wireless client device 114(3) on a LAN 118(2) associated with that AP. In other embodiments, one or more of client devices 114 may connect directly to (i.e., plug into) network ports of network device 102 through wired connections.

Wireless client devices 116 each wirelessly connect to or disconnect from, and thereby associate with or disassociate from, respective APs 114 and the associated LANs 118 when the client devices power-on or power-down in wireless connection range of the associated APs, or roam into or out of the connection range of the APs. When wireless client devices 116 are connected to associated APs 114, the wireless client devices may connect with (i.e., access and communicate with) various ones of PDs 108 through the associated APs and network device 102, so long as ports 112 provide power to the PDs being accessed, i.e., so long as the PDs are operable. When wireless client devices 114 are not connected to their respective APs 114, the wireless client devices are unable to access/communicate with the PDs.

Client devices 116 may each be uniquely associated with different sets of PDs 108, different sets of network device lights 113, or both, based on database information stored in network device 102 and/or server(s) 106. For example, client device 116(1) may be uniquely associated with PDs 108(1) and 108(2). A given client device among client devices 108 expects to be able connect with the PDs among PDs 108 with which that client device is uniquely associated when the client device is connected to the associated AP.

As mentioned above, network device 102 provides power to PDs 108 and network device lights 113. According to embodiments presented herein, network device 102 powers-off (i.e., removes power from) various ones of PDs 108 and network device lights 113 when access to those PDs and lights by client devices 116 is not needed so as to reduce network device power consumption. More specifically, network device 102 selectively and dynamically powers-on (i.e., provides power to) or powers-off various ones of PDs 108 and network device lights 112 when ones of client devices 116 associated with the various PDs and network device lights connect to (and thus are present in) or disconnect from (and thus are not present in) their respective LANs 118.

Network device 104 operates similarly to network device 102. Network device 104 selectively provides power to powered devices 122 connected to network ports 123 and lights 124 of the network device. Network device serves/connects with AP 125 and, in turn, the AP serves/wirelessly connects with wireless client devices 126(1) and 126(2) on a LAN 128 associated with the AP.

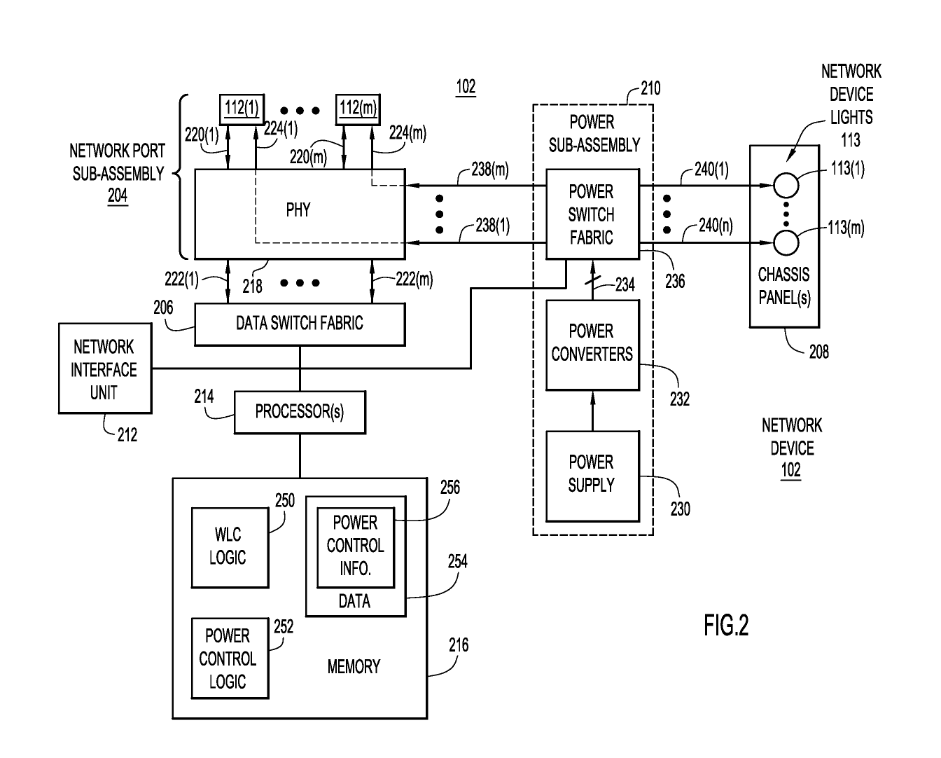

With reference to FIG. 2, there is depicted an example block diagram of network device 102. Network device 102 includes: a network port sub-assembly 204; a data switch fabric 206; network device lights 113(1)-113(N) mounted to one or more chassis panels 208 of the network device; a power sub-assembly 210 to power the network device and also selectively provide power to or remove power from the network port sub-assembly and the network device lights; a network interface unit 212 to connect with APs 114 and communicate with communication networks through wired or wireless connections; a central processing unit (CPU) 214 (also referred to simply as a “processor” 214); and a memory 216.

Network port sub-assembly 204 includes network ports 112 coupled to a PHY module 218. PHY module 218 includes transceivers (not shown in FIG. 2) allocated to each of network ports 112 and that convert between bi-direction data 220(1)-220(M) to/from the ports and bi-directional data 222(1)-222(M) from/to data switch fabric 206. PHY module 218 also provides selectively supplied power 224(1)-224(M) to ports 112 (and thus to powered devices 108(1)-108(M)), as described below.

Data switch fabric 206 selectively switches data 222 between different ones of network ports 112 and between the network ports and network interface unit 212 under control of processor 214.

Power sub-assembly 210 includes a power supply 230 to supply power to network device 102. Power supply 230 also provides power to power converters 232. Power converters 232 generate power on a plurality of power lines 234 coupled to a power switch fabric 236. Under control of processor 214, power switch fabric 236 selectively switches power carried on power lines 234 to (i) all or selected ones of power lines 238(1)-238(M) connected between the power switch fabric and PHY 218 and, (ii) all or selected ones of power lines 240(1)-240(N) connected between the switch fabric and lights 113(1)-113(N). Thus, power switch fabric 236 selectively switches power to or removes power from each of power lines 238 and each of power lines 240 under control of commands from processor 214. PHY 218 routes power on power lines 238(1)-238(M) to network ports 112(1)-112(M), respectively. Accordingly, when switch fabric 236 switches power to or removes power from a given power line 238(i)/240(i), the corresponding effect is to switch power to or remove power from network port 112(i)/light 113(i). In other embodiments, the switch functions of power switch fabric 236 may be distributed to PHY 218.

Processor 214 is, for example, a microprocessor or microcontroller that executes software instructions stored in memory 216 to perform higher level control of the operations of the network device 102.

Memory 216 may comprise volatile memory (VM) and non-volatile memory (NVM) in various forms, including read only memory (ROM), random access memory (RAM), magnetic disk storage media devices, optical storage media devices, electrical, optical, or other physical/tangible memory storage devices. Thus, in general, memory 216 may comprise one or more tangible (non-transitory) computer readable storage media (e.g., a memory device) encoded with software comprising computer executable instructions and when the software is executed (by the processor 214) it is operable to perform the techniques described herein. For example, memory 216 stores or is encoded with instructions for: Wireless LAN Controller (WLC) logic 250 to control APs 114 in various network configurations and implement communication protocols with the APs; and Power Control logic 252 to implement power control embodiments presented herein.

In addition, memory 216 stores data 254 used and generated by processor(s) 214 when executing logic 250 and 252. Data 254 includes a power control database 256 that stores power control information that uniquely associates (i.e., maps) different client devices to different sets of PDs and/or lights 113, and other data/information used by logic 252, as will be described more fully below.

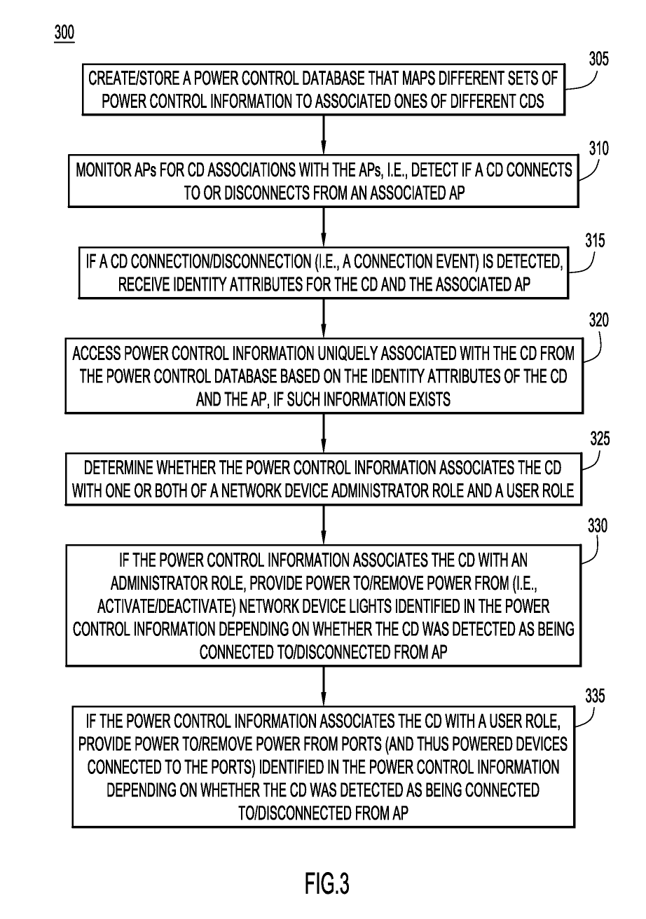

Turning now to FIG. 3, there is shown a flowchart of an example method 300 of reducing power consumption at a network device based on power control profiles associated with client devices. In an embodiment, method 300 is performed by network device 102 when processor 214 executes Power Control logic 252. Reference is also made to FIG. 1 for purposes of the description of FIG. 3.

Initially, at 305, network device 102 create/stores power control database 254. Database 254 includes information that uniquely associates (i.e., maps) different client devices 114 to corresponding different sets of power control information, including the identities of different sets of network ports to which PDs associated with the client device are connected, and/or different sets of lights 113. The lights identified in the power control information may be network port activity lights, general network device status lights, or both.

At 310, network device 102 monitors APs 114 served by the network device for AP associations with any of wireless client devices 116. That is, network device 102 detects if any of client devices 116 connect to or disconnect from associated ones of AP 114.

At 315, if a client device connection/disconnection event is detected, i.e., one of client devices 116 has connected to or disconnected from an associated one of APs 114, network device 102 receives identity attributes from the associated AP for the client device and the associated AP. Identity attributes may include a Media Access Control (MAC) address for the client device and a MAC address for the associated AP.

At 320, network device 102 accesses power control information in power control database 256 that is uniquely associated with the client device among client devices 116 that has connected to or disconnected from the associated AP based on the identity attributes of the client device and the associated AP, if such information exists in the database. In an embodiment in which the power control database is stored in server(s) 106, network device 102 access the power control information from the servers(s).

At 325, network device 102 determines whether the power control information includes information that associates the client device with one or both of a “regular” user role and a network device administrator role. For example, the client device may be associated with a network switch administrator, in which case the power control information would associate the client device with the network administrator role. On the other hand, the client device may be associated with a regular user, in which case the power control information would associate the client device with the user role.

At 330, if it is determined that the power control information associates the client device with an administrator role, network device 102 activates/deactivates (i.e., provides power to/removes power from) network device lights 113 associated with the client device as identified in an administrator power control profile in the power control information, depending on whether the client was detected as being connected to/disconnected from the associated AP. In other words, network device 102 activates/deactivates the administrator power control profile and thus powers/removes power from the network device lights 113 identified therein when the client device is detected as being connected to/disconnected from the AP.

At 335, if it is determined that the client profile information associates the client device with a user role, network device 102 provides power to/remove powers from network ports 108 (and thus the PDs connected to the ports) associated with the client device as identified in a user power control profile in the power control information, depending on whether the client device was detected as being connected to/disconnected from the associated AP (i.e., whether the client devices was detected as being associated to/not associated to the AP). In other words, network device 102 activates/deactivates the user power control profile and thus powers/removes power from the network ports (and thus PDs connected thereto) identified therein when the client device is detected as being connected to/disconnected from the AP. The user power control profile is also referred to as an “in-line power profile” because the profile identifies network ports associated with PDs or in-line devices.

In another embodiment of method 300, client devices associated with power control profiles in power control database 356 may have wired connections to network device 102 instead of wireless connections. In such embodiments, when the “wired” client device connect to/disconnect to network device 102, the network device performs method 300 modified slightly to obviate the need for an associated AP identity attribute. Thus, the appropriate power control information is accessed based on the client identity attribute alone.

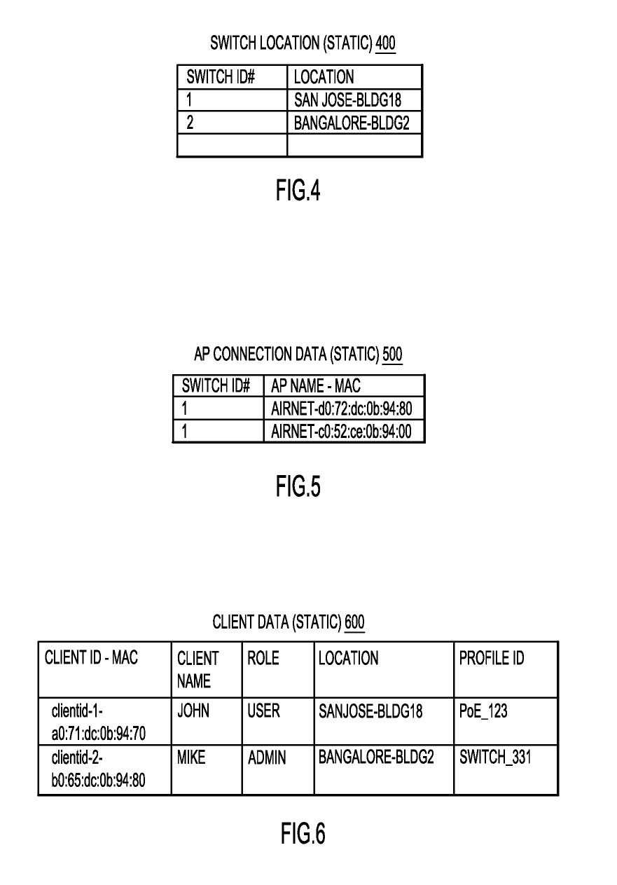

With reference to FIGS. 4-9 described below, there are illustrations of various example data structures stored in power control database 256 and accessed/used in method 300 as the power control information.

FIG. 4 is an illustration of example network device location information/data 400 that associates network device identifiers of network devices, e.g., network switches 1 and 2, with corresponding geographical locations for the switches, e.g., San Jose and Bangalore. Information 400 is “static” meaning that the information is stored in power control database 254 during system configuration or provisioning and reflects a deployed network topology that does not change merely because client devices 114 connect with or disconnect from APs 116. Static information may be entered into power control database by an administrator, for example.

FIG. 5 is an illustration of example AP connection information 500 that associates network device identifiers from information 400 in FIG. 4 with corresponding AP identifiers (e.g., MAC addresses) of APs served by each of the identified network devices.

FIG. 6 is an illustration of example client device information 600 that associates client device identifiers (e.g., client MAC addresses) with corresponding (i) client/user names, (ii), client roles (e.g., user or administrator role), (iii) geographical locations (e.g., San Jose or Bangalore), and (iv) user/administrator power control profile identifiers (e.g., PoE_{—}123 for a user role or Switch_{—}331 for an administrator role).

FIG. 7 is an example of user (role) power control profile PoE_{—}123 identified in client device information 600. In the example, user power control profile PoE 123 identifies network ports port_{—}1, port_{—}4, port_{—}5, and port_{—}25 (e.g., network ports 112(1), 112(4), etc., on network switch 102) and the respective PDs (e.g., among PDs 108) connected to those ports that are associated with the client device “clientId-1” (a user) in client device information 600. In operation, when a client device identified as clientID-1 connects with a corresponding AP, the network device that serves that AP supplies power to ports port_{—}1, port_{—}4, port_{—}5, and port_{—}25 of that network device as identified in power control profile PoE_{—}123; conversely, when client device clientID-1 disconnects from the corresponding AP, the network device removes power from the ports. This operation is referred to as activation or deactivation of the power control profile corresponding to when the client device connects to or disconnects from the associated AP.

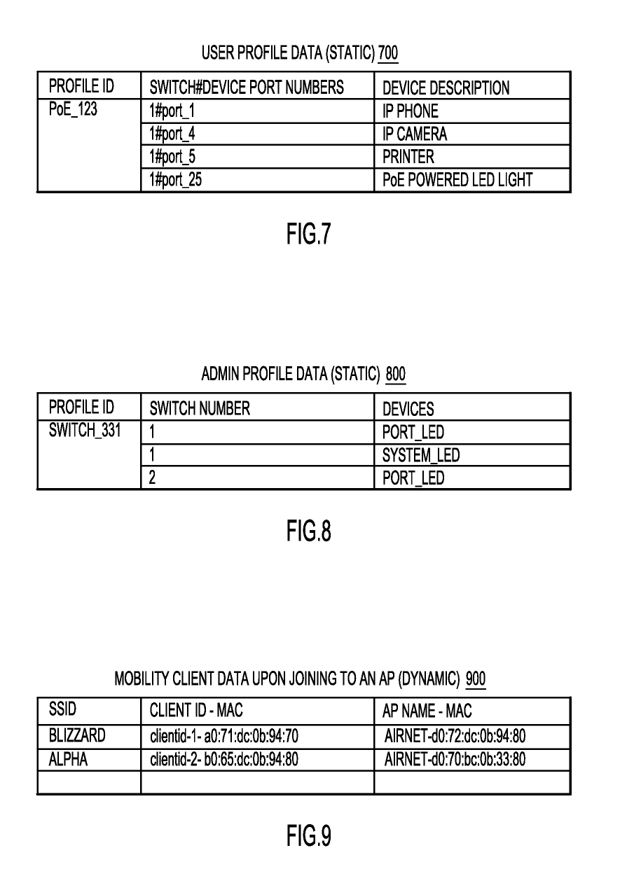

FIG. 8 is an example of administrator (role) power control profile Switch_{—}331 identified in client device information 600. Administrator power control profile Switch_{—}331 identifies enumerated network device lights, which include specific network port activity lights and general system network device status lights, associated with client device “clientId-2” (an administrator) in client device information 600. In operation, when a client device identified as clientID-2 connects with a corresponding AP, the network device that serves that AP supplies power to the network device lights identified in power control profile Switch_{—}331; conversely, when client device clientlD-2 disconnects from the corresponding AP, the network device removes power from the lights. Thus, power control profile Switch_{—}331 is activated or deactivated when client device clientID-2 connects to or disconnects from the associated AP.

FIG. 9 is an illustration of “dynamic” information 900 stored in power control database 256. Unlike static information, dynamic information 900 is updated when a client device joins/connects to or disconnects from a LAN through an associated AP. Dynamic information 900 includes a name of the LAN to which the client device has joined (e.g., blizzard), a client identifier (e.g., a MAC address) of the joined client device, and an AP identifier (e.g., a MAC address) of the associated AP.

Operationally, when a client device joins a LAN through an associated AP, network device 102 creates an entry or row in dynamic information 900 of FIG. 9. The entry identifies the LAN, the connected client device, and the associated AP (e.g., in the first row of information 900: blizzard, clientId-1-a0:71:dc:0b:94:70, and Airnet-d0:72:dc:0b:94:80, respectively).

Network device 102 uses the AP identifier (e.g., Airnet-d0:72:dc:0b:94:80) from the updated row in information 900 as a link to information 500 in FIG. 5 to derive an identifier of the network device (e.g., network device 1 in the first row of information 500) that serves that AP. Network device 102 then uses the network device identifier (e.g., 1) as a link to information 400 in FIG. 4 to derive the location (e.g., San Jose in the first row of information 400) of the network device that serves the AP.

Network device 102 also uses the client device identifier (e.g., clientId-1-a0:71:dc:Ob:94:70) from the updated row in information 900 as a link to the same client device identifier in information 600 in FIG. 6, which maps to a power control profile (e.g., PoE_{—}123) and a location (e.g., San Jose) corresponding to that client identifier in the information 600. Network device 102 verifies that the location in information 600 and information 400 match each other before activating/deactivating the power control profile.

Embodiments to reduce power at a network device, such a network switch have been described. A wireless client device associated with an authorized user. The authorized user may be a regular user or a network device administrator. The authorized user is associated with a power control profile that identifies and describes equipment powered by the network device, such as in-line devices and/or network device status lights, under control of the authorized user. When the authorized user (i.e., the client device) is within a wireless connection range or plugs into a local wired port of the network device, the equipment identified in the power control profile is powered-on; otherwise, the equipment is turned-off.

In summary, in one form, a method is provided comprising: at a network device including multiple ports to communicate with and selectively provide power to powered devices connected to corresponding ones of the ports, the network device to serve access points (APs) that connect wirelessly to client devices: detecting that a client device has wirelessly connected to or disconnected from an AP that is connected to the network device; responsive to the detecting, accessing predetermined power control information associated with the client device; and if the power control information identifies one or more of the multiple ports, selectively providing power to the identified one or more ports when the client device is detected as being connected to the AP and removing power from the identified one or more ports when the client device is detected as not being connected to the AP.

In summary, in another form, an apparatus is provided comprising: multiple network ports to supply power to devices connected to the ports; a network interface unit to connect with access points (APs) that serve wireless client devices; a power sub-assembly to provide power to or remove power from the network ports responsive to power commands; and a processor coupled to the network interface unit and the power sub-assembly, and configured to: detect that a client device has wirelessly connected to or disconnected from an AP that is connected to the network device; responsive to the detecting, access predetermined power control information associated with the client device; and if the power control information identifies one or more of the multiple ports, selectively provide power to the identified one or more ports when the client device is detected as being connected to the AP and remove power from the identified one or more ports when the client device is detected as not being connected to the AP.

In summary, in yet another form, a non-transitory computer readable storage media is provided. The media is encoded with instructions that, when executed by a processor of a network device that includes multiple ports to communicate with and selectively provide power to powered devices connected to corresponding ones of the ports, the network device to serve access points (APs) that connect wirelessly to client devices, cause the processor to: detect that a client device has wirelessly connected to or disconnected from an AP that is connected to the network device; responsive to the detecting, access predetermined power control information associated with the client device; and if the power control information identifies one or more of the multiple ports, selectively provide power to the identified one or more ports when the client device is detected as being connected to the AP and removing power from the identified one or more ports when the client device is detected as not being connected to the AP.

The above description is intended by way of example only.

What is claimed is:

1. A method comprising:
at a network device including multiple ports to communicate with and selectively provide power to powered devices connected to corresponding ones of the ports, the network device to serve access points (APs) that connect wirelessly to client devices:
detecting that a client device has wirelessly connected to or disconnected from an AP that is connected to the network device;
responsive to the detecting, accessing predetermined power control information associated with the client device; and
if the power control information identifies one or more of the multiple ports, selectively providing power to the identified one or more ports when the client device is detected as being connected to the AP and removing power from the identified one or more ports when the client device is detected as not being connected to the AP.

2. The method of claim 1, wherein the network device includes multiple network device lights to indicate network device status, the method further comprising:
if the power control information identifies network device lights associated with the client device, selectively activating or deactivating identified network device lights when the client device is detected as being connected to or disconnected from the AP, respectively.

3. The method of claim 2, wherein the network device lights include multiple port activity lights to indicate activity statuses of the multiple ports, the method further comprising:
if the power control information identifies port activity lights associated with the client device, selectively activating or deactivating the identified port activity lights.

4. The method of claim 2, further comprising:
determining whether the power control information associates the client device with a network device administrator role or a user role;
if it is determined that the client device is associated with a network device administrator role, performing the selectively activating or deactivating the identified network device lights; and
if it is determined that the client device is associated with a user role, performing the selectively providing power to or removing power from the one or more ports.

5. The method of claim 4, further comprising:
determining whether the client device is associated with a network device administrator role and a user role based on the power control information; and
if it is determined that the client device is associated with a network device administrator role and a user role, performing the selectively activating or deactivating the identified network device lights and performing the selectively providing power to or removing power from the one or more ports.

6. The method of claim 2, wherein:
the detecting includes receiving identity attributes of the client device and the associated AP; and
the accessing includes accessing the power control information based on the identity attributes.

7. The method of claim 6, wherein:
the receiving includes receiving as the identity attributes a client device identifier and an AP identifier of the AP; and
the accessing includes accessing the power control information based on the client device identifier and AP identifier.

8. The method of claim 7, wherein the accessing further includes:
accessing a network device identifier and an associated network device geographical location in the power control information based on the AP identifier; and
accessing a client profile identifier of a client power profile in the power control information based on the client identifier and the network device location, wherein the client power profile identifies at least one of (i) a first power control profile in the power control information that identifies the one or more ports, and (ii) a second power control profile in the power control information that identifies the network device lights.

9. An apparatus comprising:
multiple network ports to supply power to devices connected to the ports;
a network interface unit to connect with access points (APs) that serve wireless client devices;
a power sub-assembly to provide power to or remove power from the network ports responsive to power commands; and
a processor coupled to the network interface unit and the power sub-assembly, and configured to:
detect that a client device has wirelessly connected to or disconnected from an AP that is connected to the network device;
responsive to the detecting, access predetermined power control information associated with the client device; and
if the power control information identifies one or more of the multiple ports, selectively provide power to the identified one or more ports when the client device is detected as being connected to the AP and remove power from the identified one or more ports when the client device is detected as not being connected to the AP.

10. The apparatus of claim 9, further comprising:
one or more network device chassis panels; and
network device lights, mounted to the one or more panels, to indicate network device status when the lights are powered,
wherein the power sub-assembly provides power to or removes power from the lights responsive to the power commands, and
wherein, if the power control information identifies network device lights associated with the client device, the processor further causes the power sub-assembly to selectively provide power to or remove power from the identified network device lights when the client device is detected as being connected to or disconnected from the AP, respectively.

11. The apparatus of claim 9, wherein the processor further:
determines whether the power control information associates the client device with a network device administrator role or a user role;
if it is determined that the client device is associated with a network device administrator role, selectively activates or deactivates the identified network device lights; and
if it is determined that the client device is associated with a user role, provides power to or removes power from the one or more ports.

12. The apparatus of claim 11, wherein the processor further:
determines whether the client device is associated with a network device administrator role and a user role based on the power control information; and
if it is determined that the client device is associated with a network device administrator role and a user role, selectively activates or deactivates the identified network device lights and selectively provides power to or removes power from the one or more ports.

13. The apparatus of claim 9, wherein the processor:
detects by receiving identity attributes of the client device and the associated AP; and
accesses by accessing the power control information based on the identity attributes.

14. The apparatus of claim 13, wherein the processor:
further detects by receiving as the identity attributes a client device identifier and an AP identifier of the AP; and
further accesses by accessing the power control information based on the client device identifier and AP identifier.

15. The apparatus of claim 14, wherein the processor further accesses by:
accessing a network device identifier and an associated network device geographical location in the power control information based on the AP identifier; and
accessing a client profile identifier of a client power profile in the power control information based on the client identifier and the network device location, wherein the client power profile identifies at least one of (i) a first power control profile in the power control information that identifies the one or more ports, and (ii) a second power control profile in the power control information that identifies the network device lights.

16. A computer readable storage media encoded with instructions that, when executed by a processor of a network device that includes multiple ports to communicate with and selectively provide power to powered devices connected to corresponding ones of the ports, the network device to serve access points (APs) that connect wirelessly to client devices, cause the processor to:
detect that a client device has wirelessly connected to or disconnected from an AP that is connected to the network device;
responsive to the detecting, access predetermined power control information associated with the client device; and
if the power control information identifies one or more of the multiple ports, selectively provide power to the identified one or more ports when the client device is detected as being connected to the AP and removing power from the identified one or more ports when the client device is detected as not being connected to the AP.

17. The computer readable storage media of claim 16, wherein the network device includes multiple network device lights to indicate network device status, and instructions include instructions to cause the processor to:
if the power control information identifies network device lights associated with the client device, selectively activate or deactivate identified network device lights when the client device is detected as being connected to or disconnected from the AP, respectively.

18. The computer readable storage media of claim 17, further comprising instructions to cause the processor to:
determine whether the power control information associates the client device with a network device administrator role or a user role;
if it is determined that the client device is associated with a network device administrator role, selectively activate or deactivate the identified network device lights; and
if it is determined that the client device is associated with a user role, selectively provide power to or remove power from the one or more ports.

19. The computer readable storage media of claim 18, further comprising instructions to cause the processor to:
determine whether the client device is associated with a network device administrator role and a user role based on the power control information; and
if it is determined that the client device is associated with a network device administrator role and a user role, selectively activate or deactivate the identified network device lights and selectively provide power to or remove power from the one or more ports.

20. The computer readable storage media of claim 17, wherein:
the instructions to cause the processor to detect include instructions to cause the processor to receive identity attributes of the client device and the associated AP; and
the instructions to cause the processor to access include instruction to cause the processor to access the power control information based on the identity attributes.

21. The computer readable storage media of claim 20, wherein:
the instructions to cause the processor to receive include instructions to cause the processor to receive as the identity attributes a client device identifier and an AP identifier of the AP; and
the instructions to cause the processor to access further include instructions to cause the processor to access the power control information based on the client device identifier and AP identifier.

22. The computer readable storage media of claim 21, wherein the instructions to cause the processor to access include further instructions to cause the processor to:
access a network device identifier and an associated network device geographical location in the power control information based on the AP identifier; and
access a client profile identifier of a client power profile in the power control information based on the client identifier and the network device location, wherein the client power profile identifies at least one of (i) a first power control profile in the power control information that identifies the one or more ports, and (ii) a second power control profile in the power control information that identifies the network device lights.
